(19) United States
(12) Patent Application Publication
(10) Pub. No.: US 2026/0254813 A1
(43) Pub. Date: Aug. 27, 2026

(54) INFORMATION PROCESSING APPARATUS, METHOD, AND STORAGE MEDIUM STORING PROGRAM

(71) Applicant: CANON KABUSHIKI KAISHA, Tokyo (JP)

(72) Inventor: TETSUHIDE TAKASAKI, Tokyo (JP)

(21) Appl. No.: 19/440,719

(22) Filed: Jan. 6, 2026

(30) Foreign Application Priority Data
Jan. 9, 2025 (JP) 2025-003696

(51) Int. Cl. H04L 9/40; G06F 13/38

(52) U.S. Cl. CPC H04L 63/10; G06F 13/382; G06F 2213/0042

(57) ABSTRACT

An information processing apparatus includes: a first obtaining unit that obtains first information indicating whether or not access to a local network by an application is permitted; a second obtaining unit that obtains second information indicating a connection method between the information processing apparatus and an external apparatus; and a display control unit that, in a case where it is determined, based on the second information obtained by the second obtaining unit, that the information processing apparatus is to be connected to the external apparatus via an internal network interface of the information processing apparatus, in response to the first information obtained by the first obtaining unit indicating that the access is not permitted, displays information indicating that permission is required for the access in the connection method indicated by the second information.

### BACKGROUND

### Field of the Technology

The present disclosure relates to an information processing apparatus, a method, and a storage medium storing a program.

### Description of the Related Art

A known information processing apparatus uses a predetermined interface to perform communication with an image processing apparatus that has not been allocated an IP address.

Japanese Patent Laid-Open No. 2020-46756 discloses technology for using an application to output web content of a USB-connected image processing apparatus.

### SUMMARY

The present disclosure provides an information processing apparatus that can improve user-friendliness when an information processing apparatus establishes a connection with an external apparatus via a connection to a local network, and also to a method and a storage medium storing a program.

The present disclosure in one aspect provides an information processing apparatus comprising: at least one memory and at least one processor which function as: a first obtaining unit configured to obtain first information indicating whether or not access to a local network by an application is permitted; a second obtaining unit configured to obtain second information indicating a connection method between the information processing apparatus and an external apparatus; and a display control unit configured to, in a case where it is determined, based on the second information obtained by the second obtaining unit, that the information processing apparatus is to be connected to the external apparatus via an internal network interface of the information processing apparatus, in response to the first information obtained by the first obtaining unit indicating that the access is not permitted, display information indicating that permission is required for the access in the connection method indicated by the second information.

According to the present disclosure, it is possible to improve user-friendliness when an information processing apparatus establishes a connection with an external apparatus via a connection to a local network.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a system configuration.

FIG. 2 is a diagram illustrating a software configuration of a host computer.

FIG. 3 is a flowchart illustrating processing in the host computer.

FIG. 4 is a diagram illustrating a user interface screen.

FIG. 5 is a diagram illustrating a user interface screen.

FIG. 6 is a diagram illustrating a software configuration of the host computer.

FIG. 7 is a flowchart illustrating processing in the host computer.

FIG. 8 is a flowchart illustrating processing in the host computer.

FIG. 9 is a diagram illustrating a user interface screen.

FIG. 10 is a diagram illustrating a user interface screen.

FIG. 11 is a diagram illustrating a user interface screen.

FIG. 12 is a diagram illustrating a user interface screen.

FIGS. 13A and 13B are flowcharts illustrating processing in the host computer.

FIG. 14 is a flowchart illustrating processing in the host computer.

FIG. 15 is a flowchart illustrating processing in the host computer.

FIG. 16 is a diagram illustrating a table.

FIGS. 17A and 17B are flowcharts illustrating processing in the host computer.

FIGS. 18A and 18B are flowcharts illustrating processing in the host computer.

FIG. 19 is a flowchart illustrating processing in the host computer.

FIG. 20 is a flowchart illustrating processing in the host computer.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### System Configuration

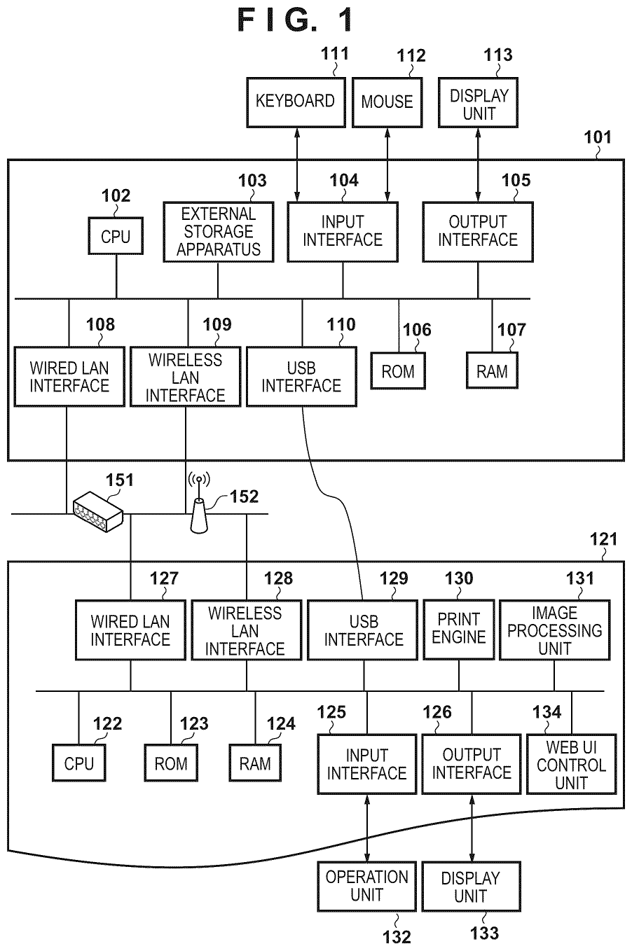

First, the configuration of a system according to the present disclosure will be described using FIG. 1.

A host computer 101 is an example of an information processing apparatus and includes a CPU 102, an external storage apparatus 103, an input interface 104, an output interface 105, a ROM 106, and a RAM 107.

Also, the host computer 101 includes a wired LAN interface 108, a wireless LAN interface 109, and a universal serial bus (USB) interface 110.

The CPU 102 is a system control unit and controls the entire host computer 101.

The CPU 102 executes various types of processing by reading out a program stored in a storage medium such as the external storage apparatus 103, the ROM 106, or the like onto the RAM 107 serving as a working area and executing the program.

The external storage apparatus 103 is a storage apparatus such as a hard disk drive (HDD), a solid state drive (SSD), or the like and stores an application program group, an operating system (OS), and various other types of data.

A keyboard 111 and a mouse 112 are connected to the input interface 104.

The input interface 104 obtains information relating to a user operation received via an input apparatus such as the keyboard 111, the mouse 112, or the like and transmits this information to the CPU 102.

A display unit 113, which is a display device such as a display, is connected to the output interface 105.

The ROM 106 is a non-volatile storage, for example, and stores an initialization program and the like executable by the CPU 102.

The wired LAN interface 108 of the host computer 101 is an interface that can perform wired communication with an external device via a router 151 or the like.

The wireless LAN interface 109 of the host computer 101 is an interface that can perform wireless communication with an external device via an external wireless LAN access point 152 or the like.

The USB interface 110 of the host computer 101 is an interface that can perform local communication with an external device.

Note that as the host computer 101, a desktop computer, a smartphone, or a laptop computer may be used, for example.

Next, the configuration of a printer 121, which is an external apparatus, will be described.

The printer 121 includes a CPU 122, a ROM 123, a RAM 124, an input interface 125, an output interface 126, a wired LAN interface 127, a wireless LAN interface 128, a USB interface 129, and a print engine 130.

An operation unit 132 is connected to the input interface 125, and a display unit 133 is connected to the output interface 126.

The CPU 122 is a system control unit and controls the entire printer 121.

The CPU 122 executes various types of processing by reading out a program stored in a storage medium such as the ROM 123 onto the RAM 124 serving as a working area and executing the program.

The print engine 130 controls a printing unit (not illustrated) that executes a print function on the basis of print data sent from the host computer 101 and prints on a print medium such as a sheet.

In the example according to the present embodiment described herein, the printer 121 is an inkjet printer that prints by discharging ink on a print medium. However, printing may be executed via a different method (for example, the electro-photographic method).

An image processing unit 131 executes various types of image processing and, for example, on the basis of a scan instruction sent from the host computer 101, scans a document placed on the glass of a platen (not illustrated) with an optical sensor and transmits the scan data to the host computer 101.

The operation unit 132 is an interface that can receive an input for various types of settings and an operation instruction from the user.

A web UI control unit 134 provides a remote UI to an external apparatus such as the host computer 101.

The user, from a web browser application executed on the host computer 101, can use a screen called a remote UI provided by the web UI control unit 134 to reference the state of the printer 121, change various types of settings, and the like.

The host computer 101 and the printer 121 can perform communication with one another by being connected via the interfaces.

For example, the USB interface 110 of the host computer 101 and the USB interface 129 of the printer 121 may be connected via a USB cable.

In a case where wired communication is performed between the wired LAN interface 108 of the host computer 101 and the wired LAN interface 127 of the printer 121, the host computer 101 and the printer 121 are connected via the router 151.

In a case where wireless communication is performed between the wireless LAN interface 109 of the host computer 101 and the wireless LAN interface 128 of the printer 121, the host computer 101 and the printer 121 are connected via the wireless LAN access point 152.

In a case where the router 151 and the wireless LAN access point 152 are on the same network, communication via wired LAN and wireless LAN can both be performed.

Thus, the wired LAN interface 108 of the host computer 101 and the wireless LAN interface 128 of the printer 121 may be connected.

Also, the wireless LAN interface 109 of the host computer 101 and the wired LAN interface 127 of the printer 121 may be connected.

Note that the router 151 and the wireless LAN access point 152 are connected to the Internet, and the host computer 101 and the printer 121 can access the Internet via the wired LAN interface or the wireless LAN interface.

In the example described above, as the method for communication between the host computer 101 and the printer 121, three types of interfaces, wired LAN, wireless LAN, and USB are used.

However, not all three types of interfaces need to be provided, and it is sufficient that one of the types of interfaces is provided.

Also, an interface different from the three types of interfaces described above may be provided.

Due to recent increased security awareness, communication via LAN by an application may be restricted, and in order for the application to perform communication with an external apparatus via LAN, there may be cases where user permission is required to access the LAN.

Also in a case where the information processing apparatus and an external apparatus are connected via an internal network interface of the information processing apparatus, in order for the application and the external apparatus to communicate, there may be cases where user permission is required to access the LAN.

For example, even if an external apparatus and the information processing apparatus are connected via a USB cable, in a case where the information processing apparatus has a configuration that also allows connection via an internal network interface, the user may be asked for permission to access the LAN.

However, in this case, the user has connected an external apparatus to the information processing apparatus via a USB cable and is not aware of the connection via the internal network interface.

Thus, the user may not realize that LAN access needs to be permitted and may not permit LAN access for an unintended connection method.

As a result, the function of communication between the application and an external apparatus may become unusable.

In the present embodiment, the user is appropriately guided to permit access to the LAN in accordance with a connection method for the information processing apparatus and the external apparatus. This can increase the user-friendliness relating to using the remote UI function and the like.

### Software Configuration of Host Computer 101

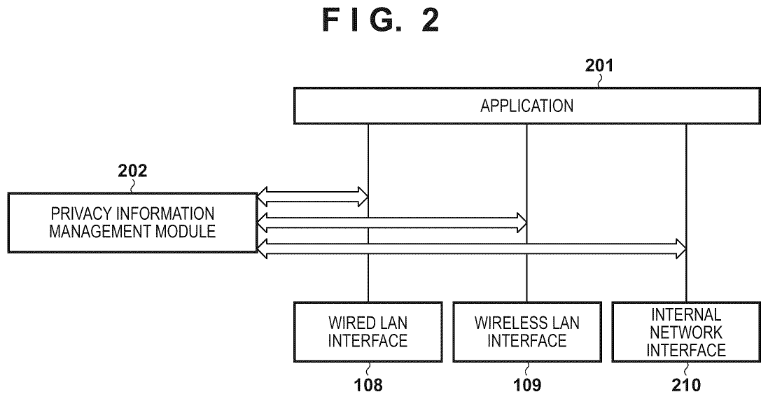

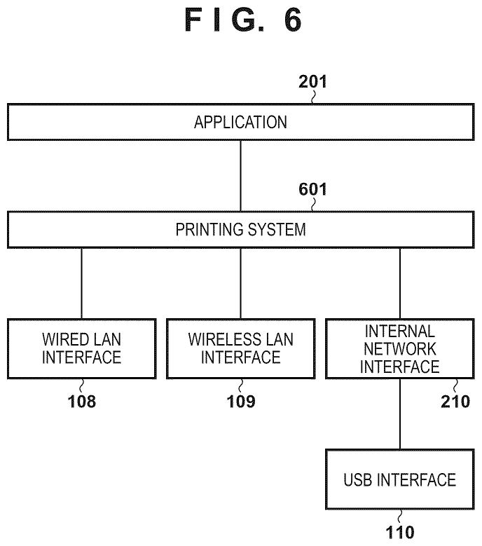

An example of the software configuration of the host computer 101 will now be described using FIGS. 2 and 6.

The OS running on the host computer 101 is system software that controls and manages the entire host computer 101.

The OS provides the basic computer management and control including the management of hardware such as a memory, hard disk, and the like and the management of processes such as an application, a system function, and the like.

Components forming the OS include a privacy information management module 202 illustrated in FIG. 2 and a printing system 601 illustrated in FIG. 6.

First, FIG. 2 will be described.

The privacy information management module 202 is an OS module that monitors use of the network interfaces by processes such as an application and manages restriction and removal of communication by processes such as an application using the network interfaces.

Processes such as an application cannot perform communication with an external apparatus unless a restriction on communication performed using the network interfaces is removed by the privacy information management module 202.

The privacy information management module 202, in the initial state, restricts communication using the network interfaces by all of the processes such as an application.

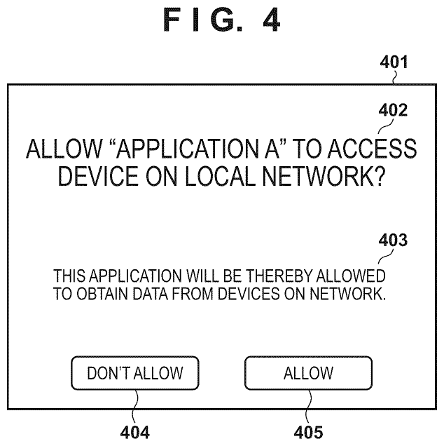

In a case where a process such as an application uses a network interface for the first time, a screen for obtaining permission to access the local network (for example, LAN) illustrated in FIG. 4 is displayed.

Here, the network interface monitored by the privacy information management module 202 is an external network interface and an internal network interface 210.

The external network interface is a network interface for performing communication with an external apparatus and includes the wired LAN interface 108 and the wireless LAN interface 109.

Also, the internal network interface 210 is a network interface for communications in the host computer 101 managed by the OS.

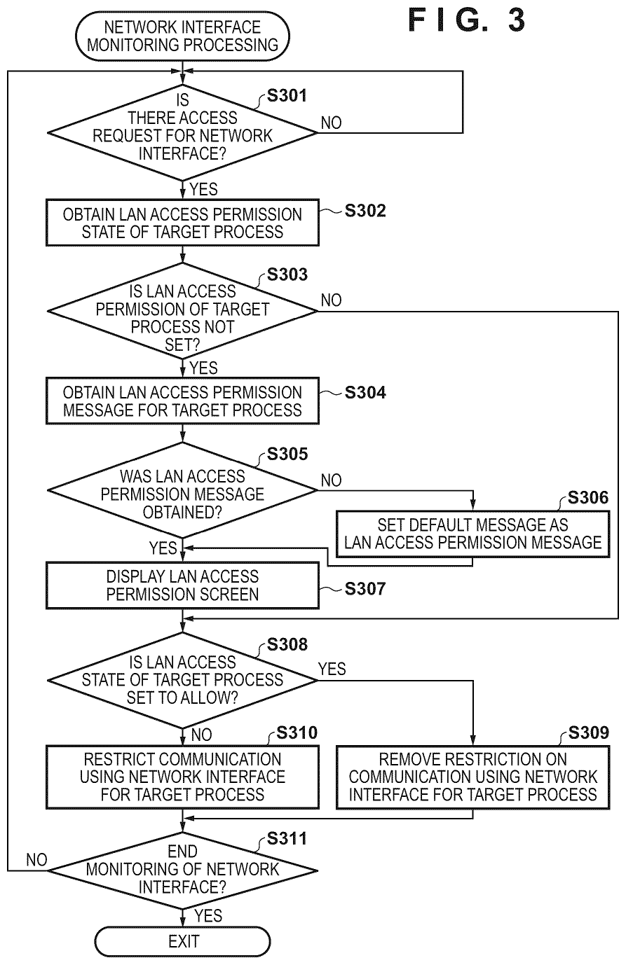

FIG. 3 is a flowchart illustrating network interface monitoring processing by the privacy information management module 202.

The processing in FIG. 3 is implemented by the CPU 102 reading out a program stored in the ROM 106 onto the RAM 107 and executing the program, for example.

After start up, the OS causes the privacy information management module 202 to execute the processing of FIG. 3 to perform network interface monitoring of processes such as an application.

The network interface monitoring processing executed by the privacy information management module 202 will be described below.

In S301, the CPU 102 determines whether or not there is an access request for a network interface via the privacy information management module 202.

In a case where it is determined that there is no access request for a network interface, the processing from S301 is repeated.

In a case where it is determined that there is an access request for a network interface, in S302, the CPU 102 obtains information of the LAN access permission state of the process which requested access to the network interface via the privacy information management module 202.

The information of the LAN access permission state includes, for example, the name of the process which requested access to the network interface and information of whether the user granted permission or not.

The privacy information management module 202 reads out the information of the LAN access permission state stored in the external storage apparatus 103 of the host computer 101.

In S303, the CPU 102 determines whether or not the LAN access permission state of the process which requested access to the network is not set via the privacy information management module 202.

For example, in a case where the name of the process which requested access to the network interface is not stored as information of the LAN access permission state in the external storage apparatus 103, it is determined that the LAN access permission state is not set.

In a case where it is determined that the LAN access permission state of the process which requested access to the network interface is not unset, the processing advances to S308.

In a case where it is determined that the LAN access permission state of the process which requested access to the network interface is not set, the processing advances to S304.

In S304, the CPU 102 obtains a LAN access permission message for the process which requested access to the network interface via the privacy information management module 202.

In S305, the CPU 102 determines whether or not the LAN access permission message for the process which requested access to the network interface was obtained via the privacy information management module 202.

In a case where it is determined that the LAN access permission message for the process which requested access to the network interface was not obtained, the processing advances to S306.

In S306, the CPU 102 sets a pre-prepared default message as the LAN access permission message via the privacy information management module 202.

For example, a message such as “This application is not permitted to obtain data from devices on the network.” is set.

After S306, the processing advances to S307.

In a case where it is determined that the LAN access permission message for the process which requested access to the network interface was obtained, the processing advances to S307.

In S307, the CPU 102 displays a screen for obtaining LAN access permission via the privacy information management module 202.

FIG. 4 is a diagram illustrating an example of a screen for obtaining LAN access permission displayed by the privacy information management module 202 in S307.

A LAN access permission screen 401 includes a main message 402 in which the target application name is described, a supplementary message 403 that the vendor who created the application can designate, a “Don't allow” button 404, and a “Allow” button 405.

Here, the supplementary message 403 is the message obtained in S304 or the default message set in S306.

Both messages may be the same, or they may be different.

In a case where the LAN access permission screen 401 is displayed and the user presses the “Don't allow” button 404, the privacy information management module 202 closes the LAN access permission screen 401.

Also, the privacy information management module 202 sets the LAN access permission state of the target application to “Don't allow”.

Also, in a case where, on the LAN access permission screen 401, the user presses the “Allow” button 405, the privacy information management module 202 closes the LAN access permission screen 401 and sets the LAN access permission state of the target application to “Allow”.

Now we will return to FIG. 3.

In S308, the CPU 102 closes the LAN access permission screen 401 via the privacy information management module 202 in response to a user operation.

Thereafter, the CPU 102 determines whether or not the LAN access permission state of the process which requested access to the network interface is set to “Allow” or “Don't allow” via the privacy information management module 202.

In a case where it is determined that the LAN access permission state of the process which requested access to the network interface is “Allow”, the processing advances to S309.

In S309, the CPU 102 removes the restriction on communication using the network interface for the process which requested access to the network interface via the privacy information management module 202.

After S309, the processing advances to S311.

In a case where it is determined that the LAN access permission state of the process which requested access to the network interface is “Don't allow”, the processing advances to S310.

In S310, the CPU 102 restricts communication using the network interface for the process which requested access to the network interface via the privacy information management module 202.

After S310, the processing advances to S311.

Via such processing, when a network interface is used by a process restricted in communications using the network interface, a communication error is generated saying that communication using the network interface is restricted.

In S311, the CPU 102 determines whether or not to end monitoring of the network interface via the privacy information management module 202.

Ending the monitoring of the network interface is requested by OS end processing or the like, for example.

In a case where it is determined to not end monitoring of the network interface, the processing from S301 is repeated.

In a case where it is determined to end monitoring of the network interface, the network interface monitoring processing of FIG. 3 is ended.

The settings for the LAN access permission can be changed from the OS settings change screen.

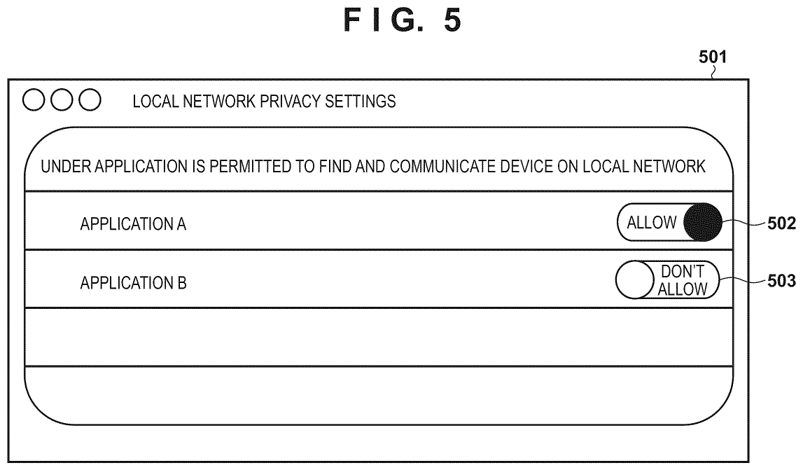

FIG. 5 is an example of a settings change screen for permission to access the LAN managed by the OS, and the privacy information management module 202 displays the screen of FIG. 5 when the user operates a settings change menu of the OS, for example.

On a settings change screen 501 for LAN access permission, applications 201 for which access permission settings have been performed on the LAN access permission screen 401 are displayed in a list, and the user can confirm and change the access permission settings.

Here, that a LAN access permission setting 502 for “Application A” is set to “Allow” and a LAN access permission setting 503 for “Application B” is set to “Don't allow” can be confirmed.

Also, the LAN access permission setting 502 for “Application A” can be changed from “Allow” to “Don't allow” or from “Don't allow” to “Allow” for the permission settings by the user operating a toggle control.

Also, the LAN access permission setting 503 for “Application B” can be changed from “Allow” to “Don't allow” or from “Don't allow” to “Allow” for the permission settings by the user operating a toggle control.

When the user changes the LAN access permission setting for the application 201 from “Allow” to “Don't allow”, the privacy information management module 202 restricts communication using the network interface for the application 201.

Also, when the user changes the LAN access permission setting for the application 201 from “Don't allow” to “Allow”, the privacy information management module 202 removes the restriction on communication using the network interface for the application 201.

Next, the printing system 601 illustrated in FIG. 6 will be described.

The printing system 601 is an OS module that provides the functions required to use the printer 121 from the host computer 101.

The printing system 601 provides an application program interface (API) for using its function from the application 201.

The API may include providing information relating to the printer 121 registered in the OS, printing instructions, and the like.

Recent OSs have a function that enables printing from a host computer instead of needing driver software provided by the vendor that manufactures the printer to be installed in the OS.

This function is referred to as a driverless printing system, and an example of a known protocol that supports this function includes IPP Everywhere (registered trademark) using Internet Printing Protocol (IPP) as a printing protocol.

In the present embodiment also, it is assumed that the OS printing system 601 and the printer 121 support IPP Everywhere.

Also, in the present embodiment, the printer 121 that supports IPP Everywhere is connected to the host computer 101 via the wired LAN interface 108 or the wireless LAN interface 109.

Also, a configuration is used in which the printer is registered in the OS and can be used from the application 201.

Furthermore, in the present embodiment, the printer 121 and the printing system 601 both support the IPP over USB protocol which expands the functionality of the IPP protocol to a USB interface.

In the present embodiment, the printer 121 that supports IPP Everywhere is connected to the host computer 101 via the USB interface 110 and the internal network interface 210.

Also, a configuration is used in which the printer 121 is registered in the OS and can be used from the application 201.

Here, in the present embodiment, in a case where the application 201 performs communication with the printer 121 using the API provided by the printing system 601, LAN access permission is not required.

However, in a case where the application 201 performs communication with the printer 121 without using the API provided by the printing system 601, LAN access permission is required.

### Application Operation Example

Next, the application 201 running on the host computer 101 will be described.

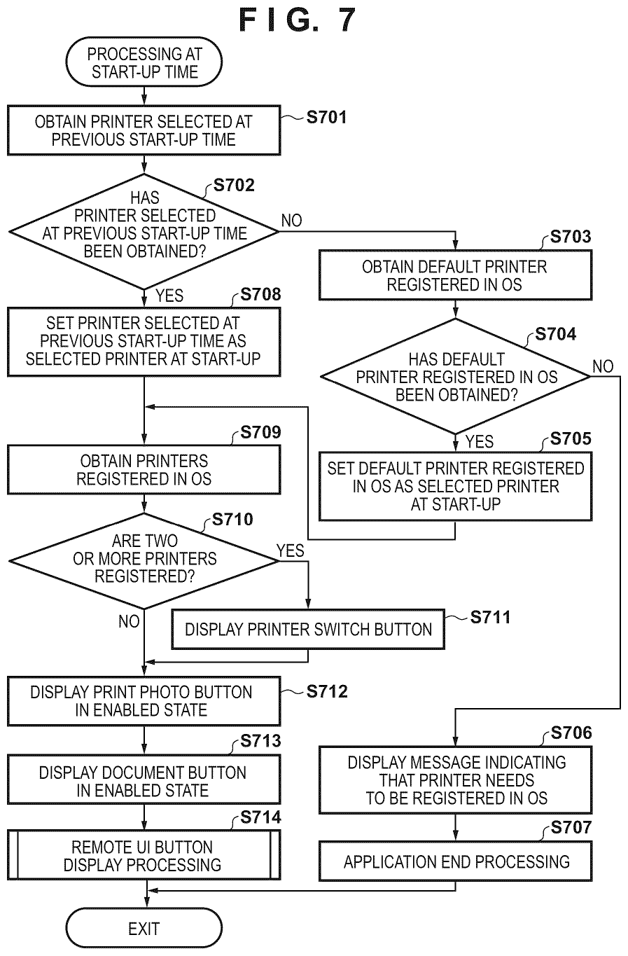

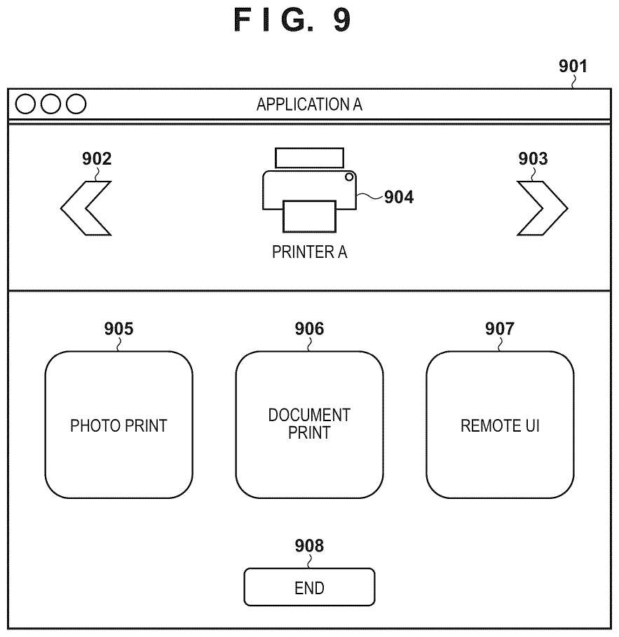

When the application 201 is activated from the OS in response to a user operation, the start-up processing illustrated in FIG. 7 is executed, and a screen 901 illustrated in FIG. 9 is displayed on the display unit 113 of the host computer 101.

The processing in FIG. 7 is implemented by the CPU 102 reading out a program stored in the ROM 106 onto the RAM 107 and executing the program, for example.

The start-up processing of the application 201 illustrated in FIG. 7 executed by the application 201 will be described below.

In S701, the CPU 102 obtains information of the printer (selected printer) selected at the previous start-up time via the application 201.

For example, the application 201 stores the information of the selected printer in the external storage apparatus 103 of the host computer 101 at the time when the application 201 is ended and reads out the information of the selected printer when the application 201 is started up.

In S702, the CPU 102 determines whether or not the information of the printer selected at the previous start-up time has been obtained via the application 201.

In a case where it is determined that the information of printer selected at the previous start-up time has been obtained, in S708, the CPU 102 sets the printer selected at the previous start-up time as the selected printer at start-up via the application 201.

Then, the CPU 102 displays the information of the selected printer in a selected printer display region 904 via the application 201.

After S708, the processing advances to S709.

On the other hand, in a case where it is determined that the information of printer selected at the previous start-up time has not been obtained, in S703, the CPU 102 obtains the information of the default printer registered in the OS via the application 201.

In S704, the CPU 102 determines whether or not the information of the default printer registered in the OS has been obtained via the application 201.

In a case where it is determined that the information of the default printer registered in the OS has not been obtained, in S706, the CPU 102 displays a message indicating that the printer needs to be registered in the OS via the application 201.

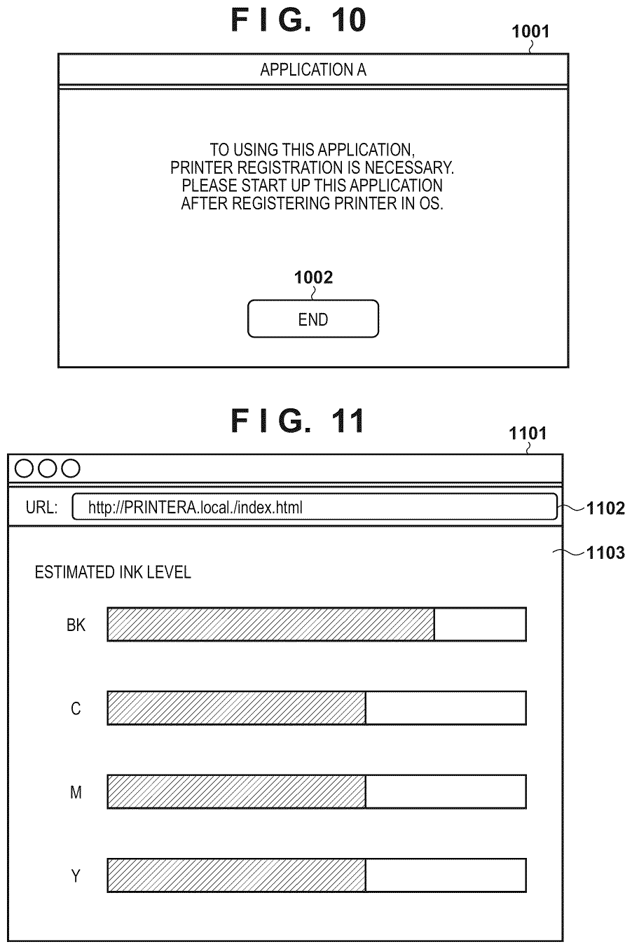

FIG. 10 is a diagram illustrating an example of a message screen displayed in S706.

As illustrated in FIG. 10, on a message screen 1001, a message indicating that the printer needs to be registered in the OS is displayed along with an end button 1002.

The end button 1002 is a button that can receive an instruction to end the application 201.

If the end button 1002 is pressed after the user has confirmed the content of the message screen 1001, in S707, the CPU 102 executes application end processing via the application 201.

Thereafter, the start-up processing of the application 201 of FIG. 7 ends.

In a case where it is determined that the information of the default printer registered in the OS has been obtained in S704, in S705, the CPU 102 sets the obtained default printer registered in the OS as the selected printer at start-up via the application 201.

Then, the CPU 102 displays the information of the selected printer in the selected printer display region 904 via the application 201.

After S705, the processing advances to S709.

In S709, the CPU 102 obtains the number of printers registered in the OS via the application 201.

Then, in S710, the CPU 102 determines whether or not two or more printers are registered in the OS via the application 201.

In a case where it is determined that two or more printers are registered in the OS, in S711, the CPU 102 displays printer switch display buttons 902 and 903.

When the user presses the printer switch display button 902 or 903, the currently selected printer can be switched to other printer registered in the OS, and the application 201 displays the post-switch printer in the selected printer display region 904.

After S711 and in a case where it is determined that two or more printers are not registered in the OS in S710, the processing advances to S712.

In S712, the CPU 102 displays a print photo button 905 in an enabled state that can receive input from a user via the application 201.

To print an image file with the currently selected printer displayed in the selected printer display region 904, the user presses the print photo button 905.

The image file may be, for example, a Joint Photographic Experts Group (JPEG) file or a Portable Network Graphics (PNG) file.

When the print photo button 905 is pressed, the application 201 displays a file selection screen. After file selection is performed by the user, a printing instruction can be issued to the currently selected printer.

In S713, the CPU 102 displays a print document button 906 in an enabled state that can receive input from a user via the application 201.

To print a Portable Document Format (PDF) file, for example, with the currently selected printer displayed in the selected printer display region 904, the user presses the print document button 906.

When the print document button 906 is pressed, the application 201 displays a file selection screen. After file selection is performed by the user, a printing instruction can be issued to the currently selected printer.

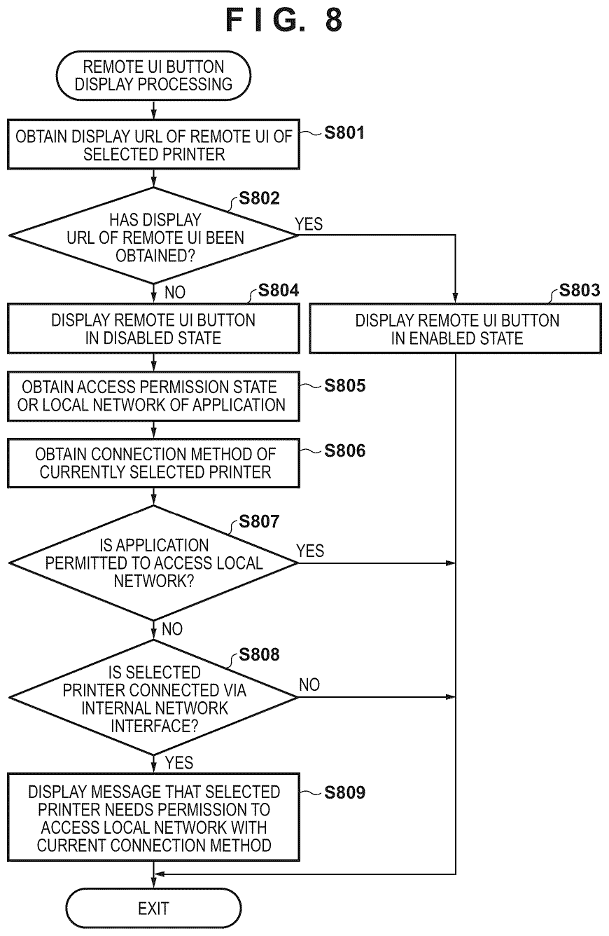

In S714, via the application 201, the CPU 102 executes display control processing of the remote UI button described below using FIG. 8 and ends the start-up processing of the application 201 of FIG. 7.

FIG. 8 is a flowchart illustrating the display control processing of the remote UI button of S714.

In S801, the CPU 102 obtains the display Uniform Resource Locator (URL) of the remote UI of the selected printer via the application 201.

Specifically, for example, the display URL of the remote UI is obtained using Bonjour, a known discovery protocol.

In the present embodiment, as the printer 121 supports the IPP as a protocol, “_ipp._tcp.” is designated as the Service Type.

Also, the target network interface corresponds to all of the network interfaces including the internal network interface and the external network interface.

As described above, in a case where the application uses a network interface for the first time, since the LAN access permission state of the application is not set, the LAN access permission screen 401 is displayed.

When the user presses the “Don't allow” button 404, if the application 201 performs a printer service discovery via the Bonjour protocol, a communication error indicating that communication using the network interface is restricted is obtained.

Also, when the user presses the “Allow” button 405, even if the application 201 performs a printer service discovery via the Bonjour protocol, a communication error indicating that communication using the network interface is restricted is not obtained.

Also, in a case where the network interface of the application has been used two times or more, whether or not to generate a communication error indicating that communication using the network interface is restricted is determined according to the LAN access permission state of the set application.

In a state where communication using the network interface is not restricted, if the application 201 performs a printer service discovery using the Bonjour protocol, a TXT Record of the printer service can be obtained.

The value of the “adminurl” key in the TXT Record of the printer service obtained by the application 201 corresponds to the display URL of the remote UI.

In S802, the CPU 102 determines whether or not the display URL of the remote UI has been obtained via the application 201.

In a case where it is determined that the display URL of the remote UI has been obtained, in S803, the CPU 102 displays a remote UI button 907 in an enabled state that can receive input from a user via the application 201.

To display the remote UI screen of the currently selected printer displayed in the selected printer display region 904, the user presses the remote UI button 907.

When the remote UI button 907 is pressed, the application 201 designates the display URL of the remote UI obtained in S801 as the URL. Then, after the web browser application has started up, the remote UI button display processing of FIG. 8 ends.

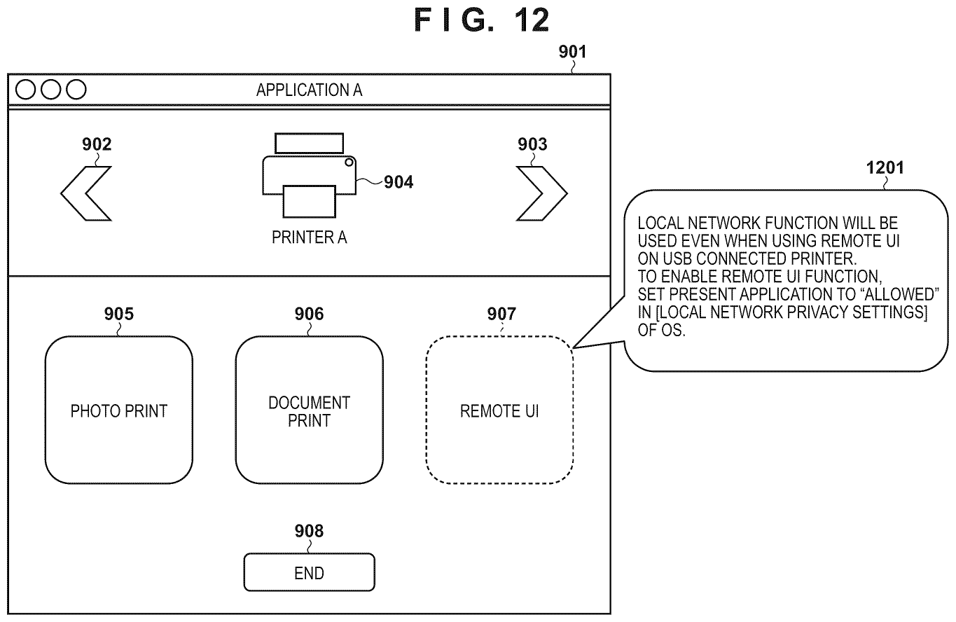

For example, in S801, in a case where “http://PRINTERA.local./index.html” is obtained as the value of the “adminurl” key in the TXT Record of the currently selected printer service, the screen of FIG. 11 is displayed.

FIG. 11 is an example of a screen of the web browser application started up by the application 201.

A web browser application screen 1101 displays the web content designated in display URL 1102 in a content display portion 1103.

In the example illustrated here, the estimated ink levels, which is the web content of “http://PRINTERA.local./index.html” corresponding to the display URL of the remote UI is displayed in the content display portion 1103.

In S802, in a case where it is determined that the display URL of the remote UI has not been obtained, in S804, the CPU 102 displays a remote UI button 907 in a disabled state that cannot receive input from a user via the application 201.

In S805, the CPU 102 sends a query to the privacy information management module 202 and obtains its LAN access permission state via the application 201.

Then, in S806, the CPU 102 sends a query to the printing system 601 and obtains the connection method with the currently selected printer via the application 201.

Specifically, for example, the Device URI is obtained as the printer connection method.

For example, in a case where the printer 121 is connected to the host computer 101 via a network, the application 201 obtains the Device URI beginning with the scheme “ipp://” via the application 201.

Also, in a case where the printer 121 is connected to the host computer 101 via USB, the application 201 obtains the Device URI beginning with the scheme “ippusb://” via the application 201.

In S807, the CPU 102 determines whether or not access to the LAN is permitted by the OS via the application 201.

In a case where access to the LAN is permitted by the OS, the remote UI button display processing of FIG. 8 ends.

On the other hand, in a case where it is determined that access to the LAN is not permitted by the OS, the processing advances to S808.

In S808, via the application 201, the CPU 102 determines whether or not the selected printer is connected to the host computer 101 via the internal network interface 210.

In a case where it is determined that the selected printer is not connected to the host computer 101 via the internal network interface 210, the remote UI button display processing of FIG. 8 ends.

On the other hand, in a case where it is determined that the selected printer is connected to the host computer 101 via the internal network interface 210, the processing advances to S809.

In S809, the CPU 102 displays a message as a tooltip UI 1201 for the disabled remote UI button 907 via the application 201 as illustrated in FIG. 12.

After S809, the remote UI button display processing of FIG. 8 ends.

The tooltip UI is a UI control displayed in a case where the mouse pointer overlaps with the button.

Also, the displayed message indicates that permission is required to access the LAN with the current connection method for the selected printer.

For example, in a case of connecting the printer 121 to the host computer 101 via a USB connection, the user does not know that the printer 121 is connected to the host computer 101 via the internal network interface.

Thus, even if the LAN access permission screen 401 is displayed when the application 201 is executed, it is plausible that the user presses the “Don't allow” button 404 as a USB connection is formed with the host computer 101.

In the present embodiment, even in such a case, via the message displayed on the tooltip UI 1201, the user can be made aware that permission is required to access the LAN of the application.

In the present embodiment, in a case where the application uses the internal network interface, a message is displayed indicating that permission is required to access the LAN with the current connection method.

However, even in a case where the application uses the external network interface, a message may be displayed indicating that permission is required to access the LAN with the current connection method.

As described above, in the present embodiment, the application determines whether an external apparatus is connected to the host computer via the internal network interface on the basis of the current connection method with the external apparatus.

Also, in a case where it is determined that the external apparatus is connected to the host computer via the internal network interface, a message is displayed indicating that permission is required to access the LAN of the application.

Accordingly, for example, in a case where the printer and the host computer 101 are connected via a USB connection and access to the LAN of the application is not permitted, the user can recognize that permission to access the LAN is required.

This can improve the user-friendliness for the user when using the remote UI function or the like.

### Second Embodiment

The differences between the second embodiment and the first embodiment will be described below.

In the first embodiment, a message is displayed in S809 indicating that permission to access the LAN is required on the basis of permission not being granted to access the LAN in a state where a communication error occurs indicating the communication using the network interface is restricted.

In the present embodiment, in such cases, if the display URL of the remote UI can be obtained by another method different from that used in S801, the remote UI button 907 is displayed in an enabled state that can receive input from a user.

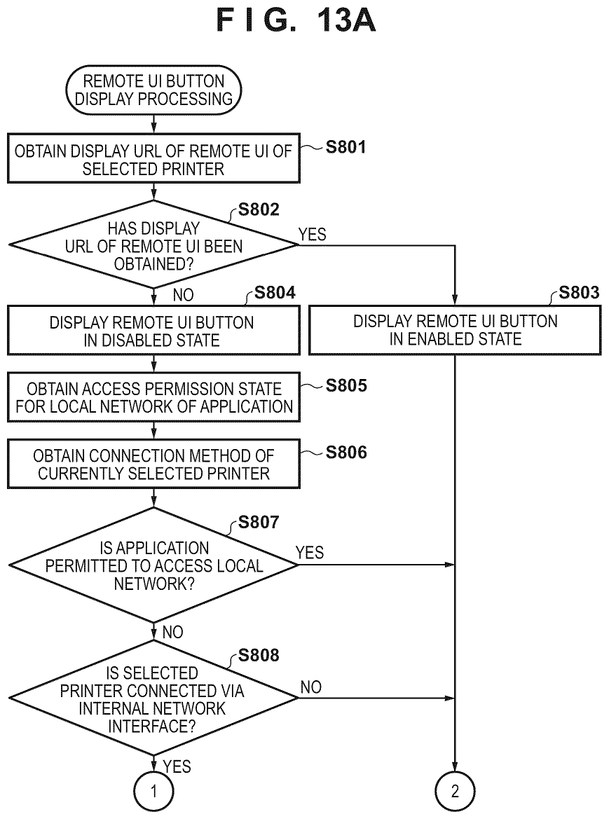

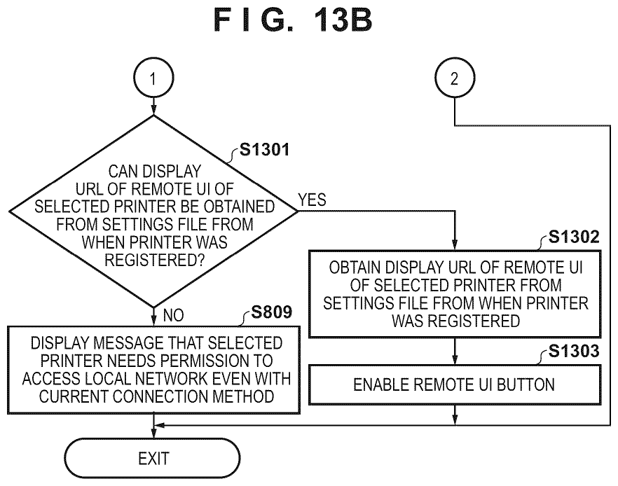

FIGS. 13A and 13B are an example of a flowchart illustrating the remote UI button display processing according to the present embodiment.

The processing in FIGS. 13A and 13B are implemented by the CPU 102 reading out a program stored in the ROM 106 onto the RAM 107 and executing the program, for example.

S801 to S808 of FIG. 13A are the same as S801 to S808 of FIG. 8 and thus description thereof will be omitted.

In S808, in a case where it is determined that the selected printer is connected to the host computer 101 via the internal network interface 210, the processing advances to S1301.

In S1301, the CPU 102 determines whether or not the display URL of the remote UI of the selected printer can be obtained from a settings file from when the printer was registered in the OS via the application 201.

For example, as the printing system 601, the Common Unix Print System (registered trademark) (CUPS) may be used.

In such a case, it is known that the value corresponding to the “adminurl” key of a PPD file, which is the settings file from when the printer was registered in the OS, corresponds to the display URL of the remote UI.

In a case where it is determined that the display URL of the remote UI of the selected printer can be obtained from the settings file from when the printer was registered in the OS, the processing advances to S1302.

In S1302, the CPU 102 obtains the display URL of the remote UI of the selected printer from a settings file from when the printer was registered in the OS via the application 201.

Then, in S1303, the CPU 102 changes the remote UI button 907 to an enabled state that can receive input from a user via the application 201.

After S1303, the remote UI button display processing of FIGS. 13A and 13B ends.

On the other hand, in S1301, in a case where it is determined that the display URL of the remote UI of the selected printer cannot be obtained from the settings file from when the printer was registered in the OS, the processing advances to S809.

S809 of FIG. 13B is the same as S809 of FIG. 8, and thus description thereof will be omitted.

As described above, in the present embodiment, it is determined whether or not the display URL of the remote UI can be obtained by a different method from accessing the LAN.

Also, in a case where it is determined that the display URL can be obtained, the display URL of the remote UI is obtained, and the remote UI button 907 is displayed in an enabled state that can receive input from a user.

This can further improve the user-friendliness for the user when using the remote user interface function.

### Third Embodiment

The differences from the first and second embodiment will be described below.

In the first embodiment, a message is displayed in S809 indicating that permission to access the LAN is required on the basis of permission not being granted to access the LAN in a state where a communication error occurs indicating the communication using the network interface is restricted.

In the present embodiment, only in a case where the access permission state is obtained before accessing the LAN at the time of executing each function and permission to access the LAN is required for the current connection method, a message is displayed indicating that access permission is required for each function.

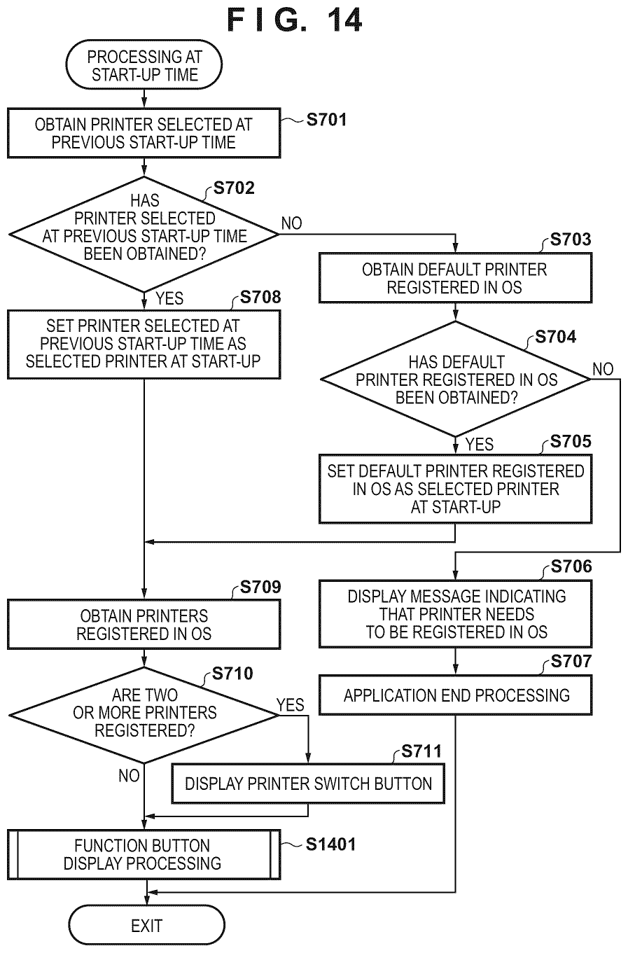

FIG. 14 is a flowchart illustrating the start-up processing of the application 201 according to the present embodiment.

The processing in FIG. 14 is implemented by the CPU 102 reading out a program stored in the ROM 106 onto the RAM 107 and executing the program, for example.

S701 to S711 of FIG. 14 are the same as S701 to S711 of FIG. 7 and thus description thereof will be omitted.

In S710, in a case where it is determined that two or more printers are not registered in the OS or after S711, the processing advances to S1401.

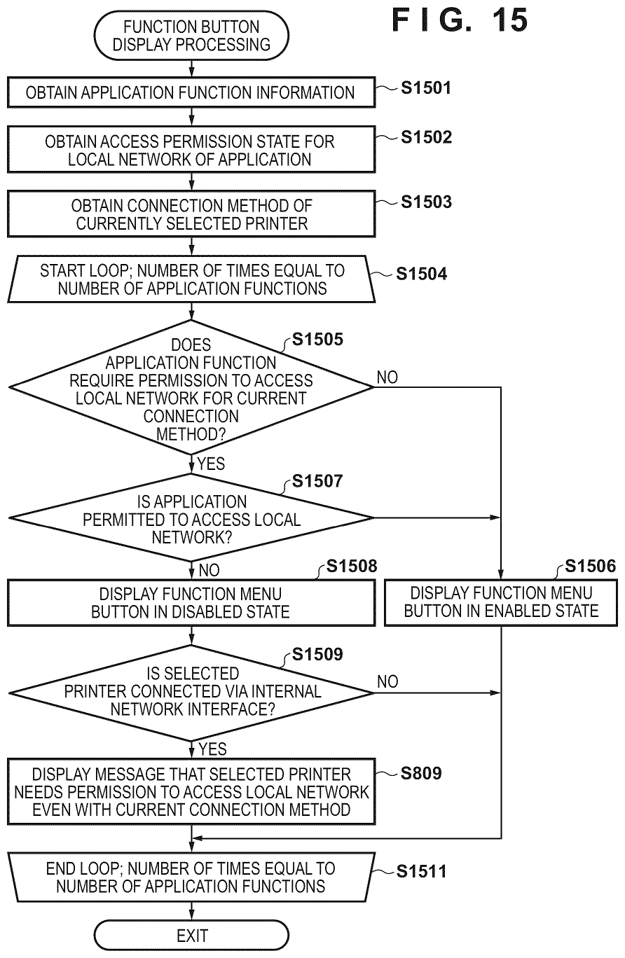

In S1401, the CPU 102 executes function button display control processing described below using FIG. 15 via the application 201.

After S1401, the processing of FIG. 14 ends.

FIG. 15 is a flowchart illustrating the function button display control processing of S1401.

The processing in FIG. 15 is implemented by the CPU 102 reading out a program stored in the ROM 106 onto the RAM 107 and executing the program, for example.

In S1501, the CPU 102 obtains application function information via the application 201.

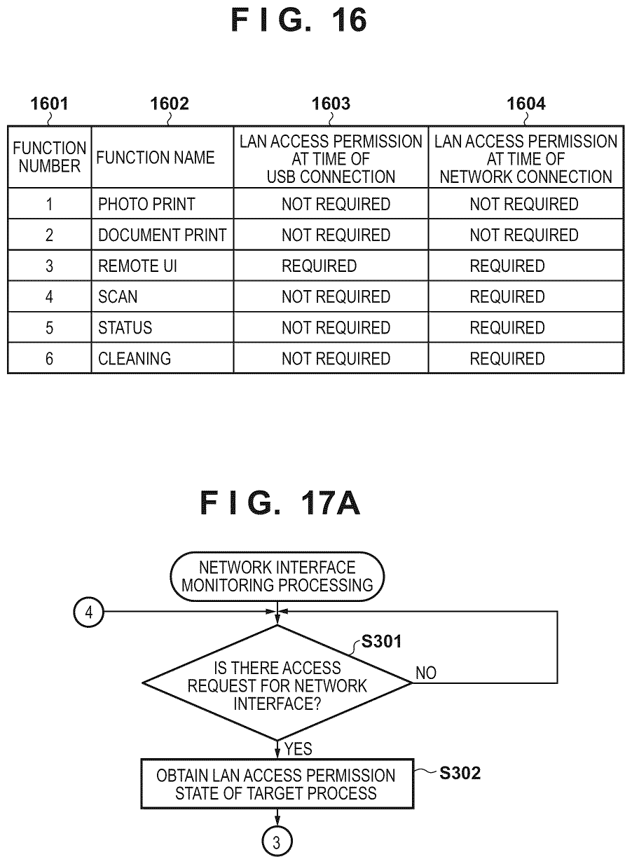

FIG. 16 is a diagram schematically illustrating an example of the application function information obtained by the application 201 in S1501.

The application function information includes information 1601 to 1604.

The information 1601 is information indicating a function number representing the display order of the function.

The information 1602 is information indicating the function name.

The information 1603 is information indicating whether LAN access permission is required at the time of USB connection.

The information 1604 is information indicating whether LAN access permission is required at the time of network connection.

In other words, the table of FIG. 16 can be considered a table indicating whether LAN access permission is required for a predetermined connection method for each function.

In S1502, the CPU 102 obtains the access permission state for the LAN of the application from the privacy information management module 202 via the application 201.

Then, in S1503, the CPU 102 obtains the connection method of the currently selected printer via the application 201.

For example, the Device URI may be obtained.

The CPU 102 repeats the following processing from S1505 to S1510 a number of times equal to the application functions obtained in S1501 via the application 201.

In S1505, the CPU 102 determines whether or not the target function requires LAN access permission for the connection method of the currently selected printer via the application 201.

In a case where it is determined that the target function does not require LAN access permission for the connection method of the currently selected printer, the processing advances to S1506.

In S1506, the CPU 102 displays a menu button of the target function in an enabled state that can receive an input from a user via the application 201.

On the other hand, in a case where it is determined that the target function does require LAN access permission for the connection method of the currently selected printer, the processing advances to S1507.

In S1507, the CPU 102 determines whether or not the application is permitted to access the LAN via the application 201.

In a case where it is determined that the application is permitted to access the LAN, in S1506, the CPU 102 displays a menu button of the target function in an enabled state that can receive an input from a user.

In a case where it is determined that the application is not permitted to access the LAN, in S1508, the CPU 102 displays a menu button of the target function in a disabled state that cannot receive an input from a user via the application 201.

Also, in S1509, via the application 201, the CPU 102 determines whether or not the selected printer is connected to the host computer 101 via the internal network interface.

In a case where it is determined that the selected printer is not connected to the host computer 101 via the internal network interface, processing in the loop is not executed, and the processing from S1505 is repeated for the next function target.

On the other hand, in a case where it is determined that the selected printer is connected to the host computer 101 via the internal network interface, the processing of S809 is executed.

S809 of FIG. 15 is the same as S809 of FIG. 8, and thus description thereof will be omitted.

Via the application 201, the CPU 102 repeats the loop processing from S1504 to S1511 a number of times equal to the number of application functions and thereafter ends the function button display control processing of FIG. 15.

Thereafter, the application start-up processing of FIG. 14 ends.

As described above, in the present embodiment, the access permission state is obtained before accessing the LAN at the time each function is executed.

Also, for each function, a message indicating that access permission is required is displayed only in a case where permission to access the LAN is required for the current connection method.

Accordingly, for each function, display control processing of the message indicating that access permission is required for the current connection method is executed. This can further improve the user-friendliness relating to using each function.

### Fourth Embodiment

The differences from the first to third embodiment will be described below.

In the first embodiment, in the case of accessing an external apparatus connected to the host computer 101 via an internal network interface without the application having permission to access the LAN, a message is displayed indicating that access permission is required for the current connection method.

In the present embodiment, the privacy information management module 202 monitors the use of the network interface of the application and sets access permission according to the type of the network interface without a user operation.

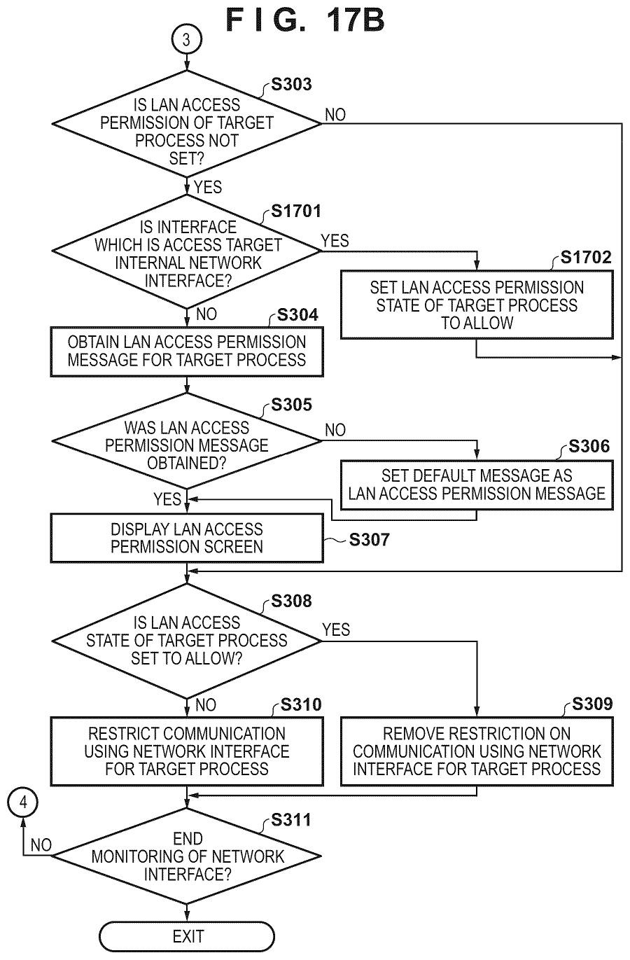

FIGS. 17A and 17B are flowcharts illustrating network interface monitoring processing executed by the privacy information management module 202 according to the present embodiment.

The processing in FIGS. 17A and 17B are implemented by the CPU 102 reading out a program stored in the ROM 106 onto the RAM 107 and executing the program, for example.

S301 to S303 of FIGS. 17A and 17B are the same as S301 to S303 of FIG. 3, and thus description thereof will be omitted.

In S303, in a case where it is determined that the LAN access permission state of the process which requested access to the network interface is not set, the processing advances to S1701.

In S1701, the CPU 102 determines whether or not the network interface which is the access target is the internal network interface via the privacy information management module 202.

In a case where it is determined that the network interface which is the access target is the internal network interface, the processing advances to S1702.

In S1702, via the privacy information management module 202, the CPU 102 sets the LAN access permission state of the process which requested access to “Allow” and thereafter executes the processing of S308.

On the other hand, in a case where it is determined that the network interface which is the access target is not the internal network interface, the processing advances to S304.

S304 to S311 of FIG. 17B are the same as S304 to S311 of FIG. 3, and thus description thereof will be omitted.

Accordingly, a process such as an application that uses an internal network interface does not require a user operation for LAN access permission. Thus, the user-friendliness relating to using the LAN access function can be further improved.

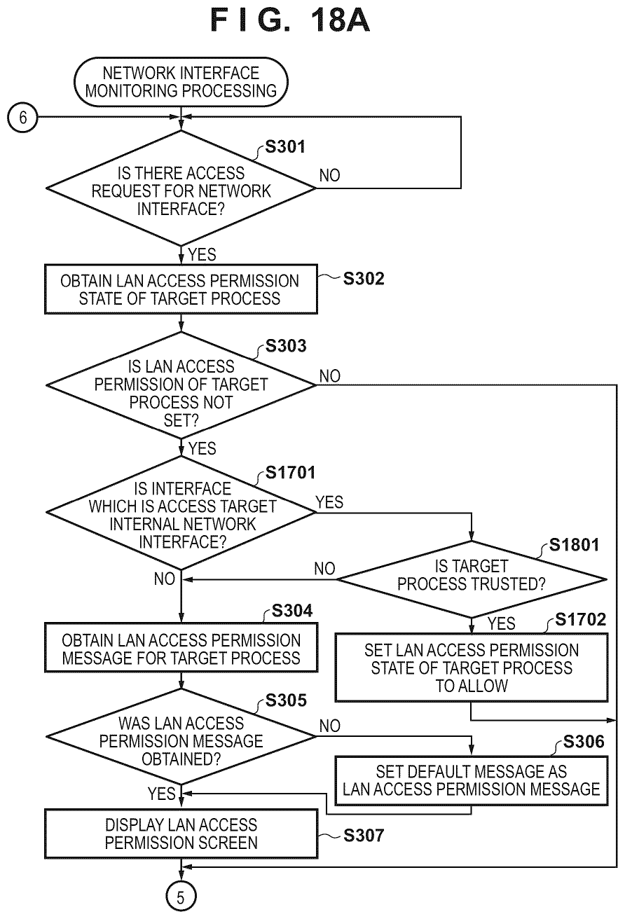

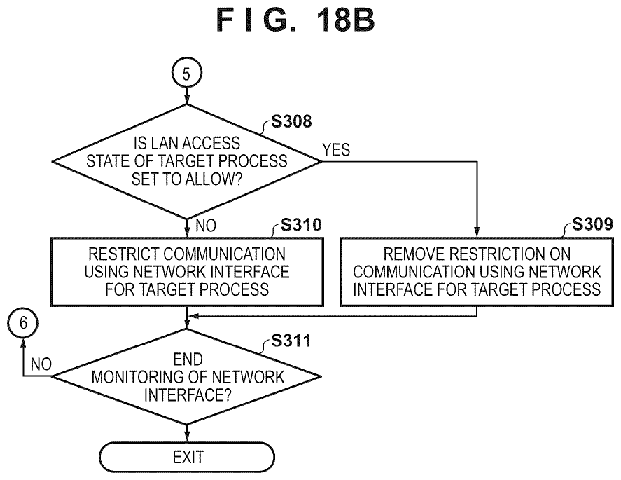

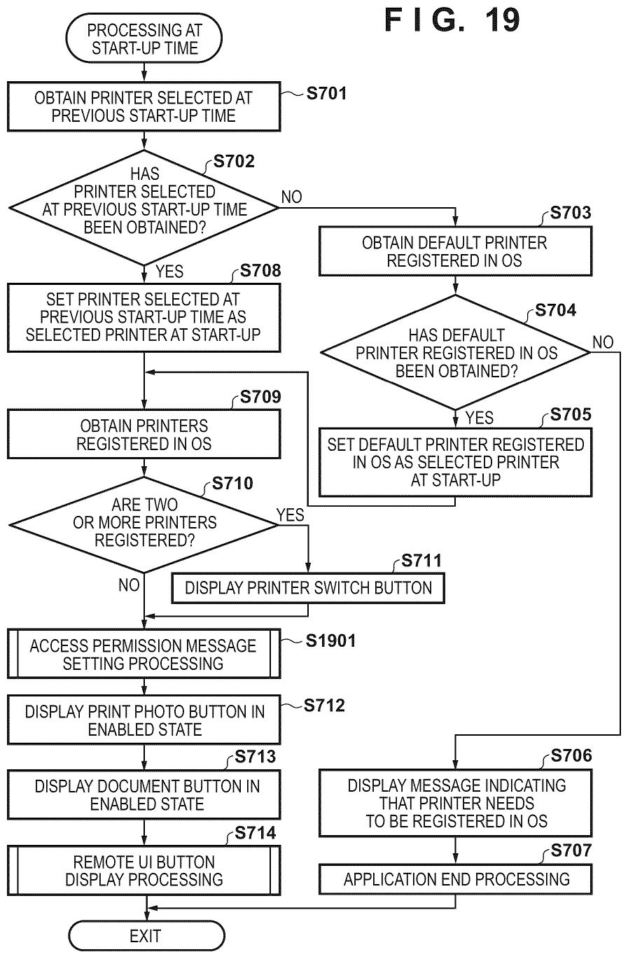

FIGS. 18A and 18B are flowcharts illustrating another network interface monitoring processing executed by the privacy information management module 202 according to the present embodiment.

By the privacy information management module 202 executing the processing illustrated in FIGS. 18A and 18B, only processes that can be trusted can be made to not require a user operation for LAN access permission in a case of using the internal network interface.

The processing in FIGS. 18A and 18B is implemented by the CPU 102 reading out a program stored in the ROM 106 onto the RAM 107 and executing the program, for example.

S301 to S303 of FIG. 18A and S1701 of FIG. 18A are the same as S301 to S303 of FIG. 3 and S1701 of FIG. 17B, and thus description thereof will be omitted.

In S1701, in a case where it is determined that the network interface which is the access target is the internal network interface, the processing advances to S1801.

In S1801, the CPU 102 determines whether or not the process which requested access to the network interface is a trusted process, that is, satisfies a condition relating to trustability, via the privacy information management module 202.

For example, in a case where the application is certified to be compliant with a security requirement set by the OS vendor via an authentication service of the OS vendor and the privacy information management module 202 has obtained this information, the process is determined to be a trusted process.

In a case where it is determined that the process which requested access to the network interface is a trusted process, the processing advances to S1702.

S1702 of FIG. 18A is the same as S1702 of FIG. 17B, and thus description thereof will be omitted.

On the other hand, in a case where it is determined that the process which requested access to the network interface is not a trusted process, the processing of S304 is executed.

S304 to S311 of FIG. 18A are the same as S304 to S311 of FIG. 3, and thus description thereof will be omitted.

Accordingly, only applications that can be trusted can be made to not require an operation for LAN access permission in a case of using the internal network interface.

This can further improve the user-friendliness for the user when using the LAN access function of a trust application.

### Fifth Embodiment

The differences from the first to fourth embodiment will be described below.

In the present embodiment, before using the network interface, the application 201 changes the LAN access permission message displayed by the privacy information management module 202 according to the connection method of the external apparatus which is the access target.

FIG. 19 is a flowchart illustrating the start-up processing of the application 201 according to the present embodiment.

The processing in FIG. 19 is implemented by the CPU 102 reading out a program stored in the ROM 106 onto the RAM 107 and executing the program, for example.

S701 to S711 of FIG. 19 are the same as S701 to S711 of FIG. 7, and thus description thereof will be omitted.

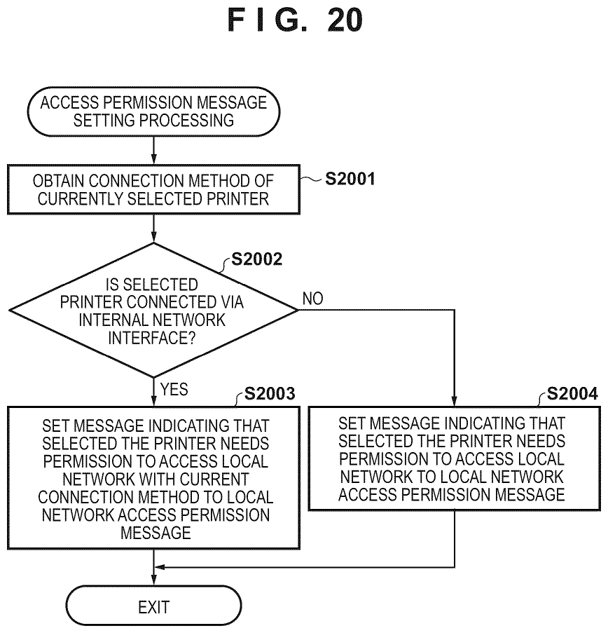

In S710, in a case where it is determined that two or more printers are not registered in the OS or after S711, access permission message setting processing of S1901 described below using FIG. 20 is executed.

After S1901, the processing of S712 to S714 is executed.

S712 to S714 of FIG. 19 are the same as S712 to S714 of FIG. 7, and thus description thereof will be omitted.

FIG. 20 is a flowchart illustrating the access permission message setting processing in S1901.

In S2001, the CPU 102 obtains the connection method information of the currently selected printer via the application 201.

In S2002, via the application 201, the CPU 102 determines whether or not the selected printer is connected to the host computer 101 via the internal network interface on the basis of the connection method information of the currently selected printer.

In a case where it is determined that the printer is connected to the host computer 101 via the internal network interface, the processing advances to S2003.

In S2003, via the application 201, the CPU 102 sets the message indicating that LAN access permission is required for the current connection method of the selected printer to a LAN access permission message displayed by the privacy information management module 202.

On the other hand, in a case where it is determined that the printer is not connected to the host computer 101 via the internal network interface, the processing advances to S2004.

In S2004, via the application 201, the CPU 102 sets the message indicating that LAN access permission is required to a LAN access permission message displayed by the privacy information management module 202.

After S2003 and S2004, the access permission message setting processing of FIG. 20 ends.

Note that the message set in S2003 and the message set in S2004 may be the same or different.

As described above, in the present embodiment, the application may be able to set the LAN access permission message displayed by the privacy information management module according to whether the selected printer is connected via the internal network interface.

### Other Embodiments

Note that the purpose of the present disclosure can naturally also be achieved by a storage medium storing a program code for software to implement the functions of the embodiment examples described above being provided to a system or apparatus, and a computer (or CPU or MPU) of the system or apparatus reading out and executing the program code stored on the storage medium.

In this case, the program code read out from the storage medium implements the functions of the embodiments described above, and the storage medium storing the program code constitutes the present disclosure.

Examples of a storage medium that can be used to provide a program code include a flexible disk, a hard disk, an optical disk, a magneto-optical disk, CD-ROM, CD-R, a magnetic tape, a non-volatile memory card, ROM, a DVD, and the like.

Also, not only can the functions of the embodiment examples described above be implemented by the computer executing the read program code, but naturally also the functions of the embodiments described above may be implemented by the operating system (OS) or the like running on a computer executing a part or all of the actual processing on the basis of an instruction in the program code.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-003696, filed Jan. 9, 2025 which is hereby incorporated by reference herein in its entirety.

What is claimed is:

1. An information processing apparatus comprising:
at least one memory and at least one processor which function as:
a first obtaining unit configured to obtain first information indicating whether or not access to a local network by an application is permitted;
a second obtaining unit configured to obtain second information indicating a connection method between the information processing apparatus and an external apparatus; and
a display control unit configured to, in a case where it is determined, based on the second information obtained by the second obtaining unit, that the information processing apparatus is to be connected to the external apparatus via an internal network interface of the information processing apparatus, in response to the first information obtained by the first obtaining unit indicating that the access is not permitted, display information indicating that permission is required for the access in the connection method indicated by the second information.

2. The information processing apparatus according to claim 1, wherein the display control unit sets a receiving unit for receiving an instruction to execute a function of the external apparatus to a receiving-disabled state when displaying the information indicating that permission is required for the access.

3. The information processing apparatus according to claim 2, wherein the at least one memory and at least one processor further function as:
a third obtaining unit configured to obtain, inside the information processing apparatus, information for displaying the receiving unit, and
in a case where the information for displaying the receiving unit is obtained by the third obtaining unit, the display control unit sets the receiving unit to a receiving-enabled state and does not display the information indicating that permission is required for the access.

4. The information processing apparatus according to claim 3, wherein the information for displaying the receiving unit is a Uniform Resource Locator (URL).

5. The information processing apparatus according to claim 1, wherein the at least one memory and at least one processor further function as:
a first determination unit configured to determine, based on the second information obtained by the second obtaining unit, whether or not the information processing apparatus is to be connected to the external apparatus via the internal network interface.

6. The information processing apparatus according to claim 5, wherein the determination performed by the first determination unit is performed for each function of the external apparatus.

7. The information processing apparatus according to claim 6, wherein in a case where the first determination unit determines that the information processing apparatus is to be connected to the external apparatus via the internal network interface, in response to the first information obtained by the first obtaining unit indicating that the access is not permitted, the display control unit sets a receiving unit for receiving an instruction to execute a function of the external apparatus corresponding to a determination target to a receiving-disabled state when displaying the information indicating that permission is required for the access.

8. The information processing apparatus according to claim 5, wherein the at least one memory and at least one processor further function as:
a second determination unit configured to determine whether or not permission to access the local network is required in the connection method between the information processing apparatus and the external apparatus indicated by the second information obtained by the second obtaining unit, and
the first determination unit performs the determination in a case where the second determination unit determines that permission to access the local network is required.

9. The information processing apparatus according to claim 8, wherein the at least one memory and at least one processor further function as:
a storage unit configured to store information specifying whether permission to access the local network is required for each function of the external apparatus, and
the second determination unit determines whether or not permission to access the local network is required, based on the information stored in the storage unit.

10. The information processing apparatus according to claim 1, wherein the first obtaining unit obtains the first information from a result of a setting of a program for setting whether or not to permit access to the local network.

11. The information processing apparatus according to claim 10, wherein the program is a program that, in a case where whether or not access to the local network is permitted has not been set, displays a screen that can receive an instruction to permit or not permit access to the local network.

12. The information processing apparatus according to claim 11, wherein the program is a program that, in a case where whether or not access to the local network is permitted has not been set, sets permission to access the local network if an access target of the application is the internal network interface.

13. The information processing apparatus according to claim 12, wherein the program is a program that, in a case where whether or not access to the local network is permitted has not been set and furthermore the access target of the application is the internal network interface, sets permission to access the local network if the application satisfies a condition relating to trustability.

14. The information processing apparatus according to claim 11, wherein the at least one memory and at least one processor further function as:
a setting unit configured to set information to be displayed on the screen that can receive an instruction to permit or not permit access to the local network.

15. The information processing apparatus according to claim 14, wherein the setting unit sets different information between a case where the information processing apparatus is to be connected to the external apparatus via the internal network interface and a case where the information processing apparatus is not to be connected to the external apparatus via the internal network interface.

16. The information processing apparatus according to claim 10, wherein the program is an Operating System (OS) program.

17. The information processing apparatus according to claim 1, wherein the connection method between the information processing apparatus and the external apparatus is a Universal Serial Bus (USB) connection.

18. The information processing apparatus according to claim 1, wherein the external apparatus is a printer, and
the application is an application that can execute a function of a printer.

19. The information processing apparatus according to claim 1, wherein the first obtaining unit, the second obtaining unit, and the display control unit are included in the application.

20. A method executed by an information processing apparatus, comprising:
obtaining first information indicating whether or not access to a local network by an application is permitted;
obtaining second information indicating a connection method between the information processing apparatus and an external apparatus; and
in a case where it is determined, based on the obtained second information, that the information processing apparatus is to be connected to the external apparatus via an internal network interface of the information processing apparatus, in response to the obtained first information indicating that the access is not permitted, displaying information indicating that permission is required for the access in the connection method indicated by the second information.

21. A non-transitory computer-readable storage medium storing a program configured to cause a computer to function to:
obtain first information indicating whether or not access to a local network by an application is permitted;
obtain second information indicating a connection method between an information processing apparatus and an external apparatus; and
in a case where it is determined, based on the obtained second information, that the information processing apparatus is to be connected to the external apparatus via an internal network interface of the information processing apparatus, in response to the obtained first information indicating that the access is not permitted, display information indicating that permission is required for the access in the connection method indicated by the second information.
